(19) United States
(12) Patent Application Publication
(10) Pub. No.: US 2007/0219919 A1
(43) Pub. Date: Sep. 20, 2007

(54) Process of accessing licensed digital content on MediaDirect enabled systems in a multiple operating system environment

(76) Inventors: Shree A. Dandekar, Round Rock, TX (US); Jeremy Friedlander, Austin, TX (US); Christopher W. Ramirez, Cedar Park, TX (US)

Correspondence Address: HAMILTON & TERRILE, LLP, P.O. BOX 203518, AUSTIN, TX, 78720, US

(21) Appl. No.: 11/377,062

(22) Filed: Mar. 16, 2006

(51) Int. Cl. G06Q 99/00

(52) U.S. Cl. 705/59

(57) ABSTRACT

A process for accessing digital content on instant on enabled information handling systems in which the instant on enabled information handling system includes a license management module that resides within a main operating system partition. When a user attempts to access licensed digital content via a instant on partition, the instant on media application accesses the license management module that resides within the main operating system partition to verify that a license is available.

### BACKGROUND OF THE INVENTION

1. Field of the Invention

The present invention relates to information handling systems and more particularly to accessing digital content on MediaDirect enabled information handling systems having systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems with a MediaDirect application. MediaDirect is an example of an instant on media application which provides an instant on function to enable fast access to files such as media files. Known MediaDirect enabled systems can include the MediaDirect solution via a separate (possibly hidden) partition. In some MediaDirect enabled systems, the separate partition image includes an XP embedded (XPe) operating system (OS), platform drivers and the MediaDirect application.

Known MediaDirect enabled systems present challenges. For example, a. MediaDirect partition can be directly accessed by the customer when the customer actuates a MediaDirect button. However, no network connection is available when the customer uses MediaDirect in this way. Additionally, no digital rights management content can be played when the customer is operating in the MediaDirect hidden partition.

It would be desirable to add support for digital content to MediaDirect so that the digital content can be presented via the MediaDirect partition. The digital content can include time sensitive content or digital rights managed licensed (i.e., limited licensed) content. For example, it would be desirable to enable trials of games such as WildTangent Games on the MediaDirect partition. However, because the WildTangent Games are factory installed on the main OS partition, the expiration time of the license to the WildTangent Games is monitored on the main OS. To enable the same game on a MediaDirect partition, a mechanism to track usage on MediaDirect partition and synchronize this with the usage on the main OS partition is needed. Thus, if a game has a total of 10 trials a user could play the game 5 times on each partition after which he will be prompted to purchase the game. Also for example, it would be desirable to enable audio content such as audio content available from the PLAYFORSURE content service on MediaDirect partition. If the audio content were enabled, a customer could download an audio file such as a PLAYFORSURE track on the main OS partition and listen to the audio content through the MediaDirect partition.

### SUMMARY OF THE INVENTION

In accordance with the present invention, process for accessing digital content on instant on enabled information handling systems is set forth in which the instant on enabled information handling system includes a license management module that resides within a main operating system partition. When a user attempts to access licensed digital content via an instant on partition, the instant on media application accesses the license management module that resides within the main operating system partition to verify that a license is available.

The license management module includes a digital rights manager as well as license meta data. The license meta data is updated by the digital rights manager whenever the user is logged into the main operating system partition. The digital rights manager invokes a responsible application for license access. The application determines whether there are enough licensed accesses available and updates the meta data accordingly. For example, if a game has 20 licensed accesses and a customer has already played the game on the main operating system partition 10 times, then the meta data on the main partition is updated so that access is granted for playing the game on the extended partition for up to the remaining ten authorized accesses. After obtaining access via the instant on partition, the meta data is updated which then updates an authorized license usage count on the main operating system partition as well updating the information on the appropriate application server via, for example, the Internet. The meta data is accessed every time a customer tries to play licensed content on the extended partition. The operation of the process is seamless and happens substantially instantaneously from the perspective of the user. If the license on the content has expired as indicated by the meta data, then the instant on partition will message the user that the content cannot play due to the expired license.

Thus, the process enables sharing of digital content among a plurality of distinct partitions. The process also provides a solution for tracking of content license expiration among a plurality of distinct partitions. By simplifying access to content, the process promotes the use (and potential purchase) of content from an information handling system supplier.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system.

FIG. 2 shows a flow chart of the operation of the process for enabling sharing of content among a plurality of distinct partitions.

### DETAILED DESCRIPTION

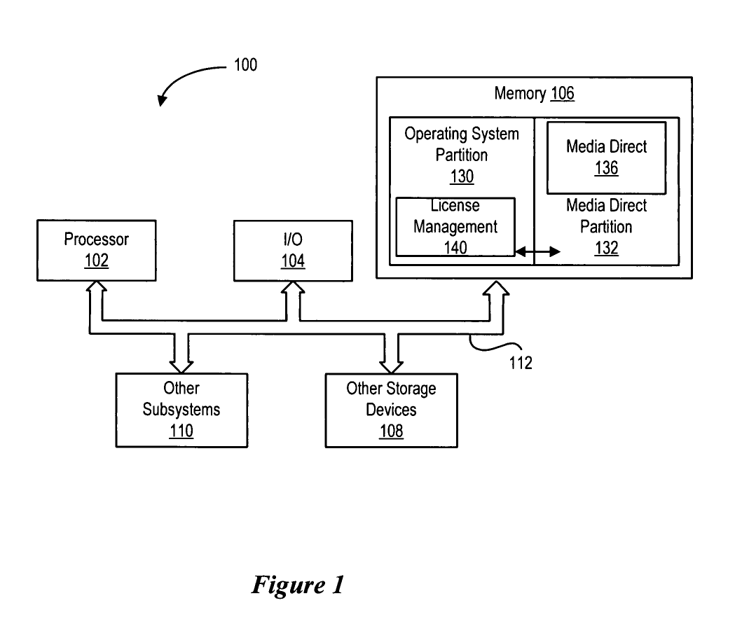

Referring briefly to FIG. 1, a system block diagram of an information handling system 100 is shown. The information handling system 100 includes a processor 102, input/output (I/O) devices 104, such as a display, a keyboard, a mouse, and associated controllers, memory 106 including non-volatile memory such as a hard disk drive and volatile memory such as random access memory, and other storage devices 108, such as a CD ROM or DVD disc and drive, and various other subsystems 110, all interconnected via one or more buses 112. The hard disk drive of the memory 106 includes a main operating system partition 130 and an instant on (e.g., MediaDirect) partition 132. The instant on partition 132 includes an instant on media (e.g., MediaDirect) application 136. The main operating system partition 130 includes a license management module 140 which communicates with the instant on media application 136 stored on the instant on partition 132.

The license management module 140 enables a user to access digital content on instant on (such as MediaDirect) enabled information handling system 100. When a user attempts to access licensed digital content via an instant on partition 132, the instant on media application 136 accesses the license management module 140 that resides within the main operating system partition 130 to verify that a license is available.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

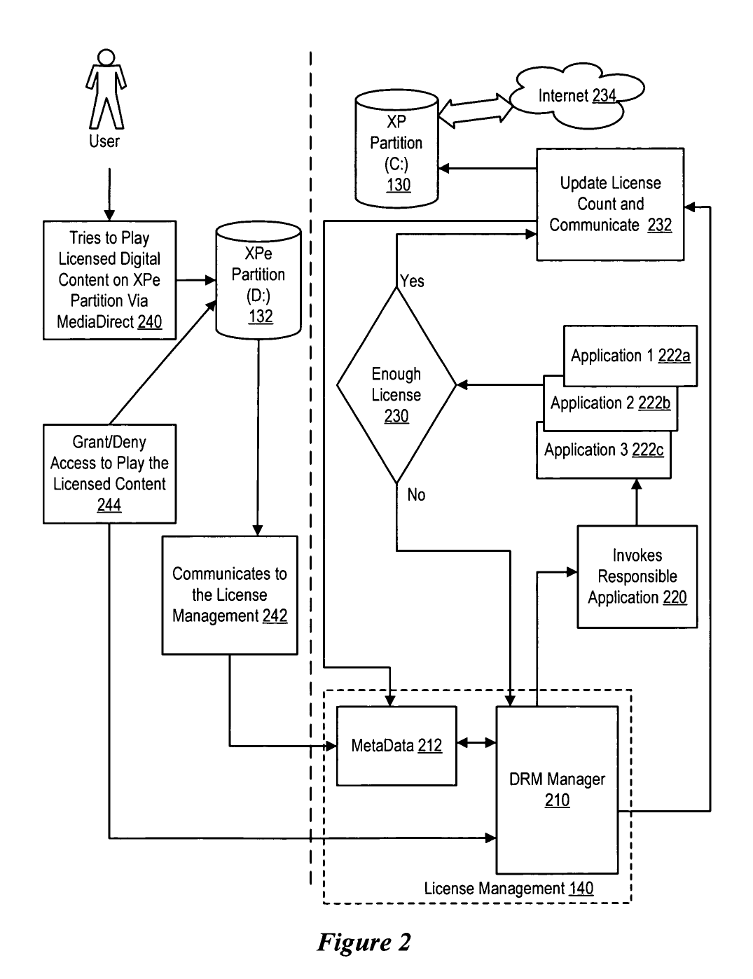

Referring to FIG. 2, a flow chart of the operation of the process for enabling sharing of content among a plurality of distinct operating system partitions is shown. More specifically, the license management module 140 includes a digital rights manager 210 as well as license meta data 212. The license meta data 212 is updated by the digital rights manager 210 whenever the user is logged into the main operating system partition 130.

The digital rights manager 210 invokes (at step 220) a responsible application 222a, 222b, 222c for license access. The application 222 determines whether there are enough licensed accesses available at step 230 and updates the license count at step 232. This updated license count is communicated to the meta data 212 as well as the appropriate license provider (e.g., via the Internet 234). For example, if a game has 20 licensed accesses and a customer has already played the game on the main operating system partition 10 times, then the meta data 212 on the operating system partition 130 is updated so that access is granted for playing the game on the extended media partition 132 for up to the remaining ten authorized accesses.

When a user attempts to access license content on the extended instant on partition 132 via the instant on application 136 at step 240, the instant on application 136 communicates with the license management module 140 (and more specifically, the license meta data 212 of the license management module 140) at step 242. The license meta data 212 indicates whether there are enough license access available to permit accessing the digital content. The instant on application 136 then grants or denies access to play the license content based upon the response from the meta data at step 244.

After obtaining access via the extended instant on partition 132, the instant on application 136 updates the license meta data 212. The next time that the operating system partition 130 is accessed, the license meta data 212 and the digital rights manager 210 update an authorized license usage count 232 as well updating the information on the appropriate application server via, for example, the Internet. The meta data is accessed and updated every time a customer attempts to play licensed content on the extended partition. The operation of the process is seamless and happens substantially instantaneously from the perspective of the user. If the license on the content has expired as indicated by the meta data, then the instant on partition 132 provides a message the user that the content cannot play due to the expired license.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, other types of instant on media applications in addition to the MediaDirect application are within the scope of the invention.

Consequently, the invention is intended to be limited only by the spirit and scope of the appended claims, giving full cognizance to equivalents in all respects.

What is claimed is:

1. A method for accessing digital content on an information handling systems comprising
providing the information handling system with a first operating system partition and a second operating system partition,
storing a license module within the first operating system partition, accessing licensed content from the second operating system partition,
determining via the license management module stored on the first operating system partition whether there are available licenses to play the licensed content.

2. The method of claim 1 wherein
the license module includes a digital rights manager and license meta data, the license meta data indicating whether there are available licenses to play the license content.

3. The method of claim 2 further comprising
updating the license meta data whenever the first operating system partition is accessed.

4. A method for accessing digital content on instant on enabled information handling systems comprising
providing the information handling system with an instant on media application within an instant on partition and a license module within a main operating system partition,
accessing licensed content with the instant on media application on the instant on partition,
determining via the license management module whether there are available licenses to play the licensed content.

5. The method of claim 4 wherein
the license module includes a digital rights manager and license meta data, the license meta data indicating whether there are available licenses to play the license content.

6. The method of claim 5 further comprising
updating the license meta data whenever the operating system partition is accessed.

7. The method of claim 4 further comprising
providing a message to a user indicating whether there are available license when the license content is accessed via the instant on media application.

8. The method of claim 4 further comprising
updating a number of available licenses when the license content is accessed via the operating system partition; and,
communicating with a license content provider via the license module when a number of available licenses is updated.

9. The method of claim 4 further comprising
updating a number of available licenses indicia within the license module when the license content is accessed via the instant on partition; and,
communicating with a license content provider via the license module when the operating system partition is accessed after the number available license indicia has been updated.

10. An apparatus for accessing digital content on an instant on enabled information handling systems comprising
an instant on media application stored within an instant on partition;
a license module stored within a main operating system partition,
means for accessing licensed content with the instant on media application on the instant on partition,
means for determining via the license management module whether there are available licenses to play the licensed content.

11. The apparatus of claim 10 wherein
the license module includes a digital rights manager and license meta data, the license meta data indicating whether there are available licenses to play the license content.

12. The apparatus of claim 11 further comprising
means for updating the license meta data whenever the operating system partition is accessed.

13. The apparatus of claim 10 further comprising
means for providing a message to a user indicating whether there are available license when the license content is accessed via the instant on media application.

14. The apparatus of claim 10 further comprising
means for updating a number of available licenses when the license content is accessed via the operating system partition; and,
means for communicating with a license content provider via the license module when a number of available licenses is updated.

15. The apparatus of claim 10 further comprising
means for updating a number of available licenses indicia within the license module when the license content is accessed via the instant on partition; and,
means for communicating with a license content provider via the license module when the operating system partition is accessed after the number available license indicia has been updated.

16. An information handing system comprising
a processor;
memory coupled to the processor, the memory including an operating system partition and an instant on partition;
a license module stored within the main operating system partition, the license module indicating whether there are available licenses to play licensed content;
an instant on media application stored within the instant on partition, the instant on media application accessing licensed content with the instant on media application on the instant on partition, the instant on media application accessing the license module to determine whether there are licenses available to place the licensed content.

17. The information handling system of claim 16 wherein
the license module includes a digital rights manager and license meta data, the license meta data indicating whether there are available licenses to play the license content.

18. The information handling system of claim 17 wherein
the license module updates the license meta data whenever the operating system partition is accessed.

19. The information handling system of claim 16 wherein
the instant on media application provides a message to a user indicating whether there are available license when the license content is accessed via the instant on media application.

20. The information handling system of claim 16 wherein
the license module updates a number of available licenses when the license content is accessed via the operating system partition; and,
the license module communicates with a license content provider when the number of available licenses is updated.

21. The information handling system of claim 16 wherein
the instant on media application updates a number of available licenses indicia within the license module when the license content is accessed via the instant on partition; and,
the license module communicates with a license content provider when the operating system partition is accessed after the number available license indicia has been updated.
